(19) United States
(12) Patent Application Publication
(10) Pub. No.: US 2026/0252943 A1
(43) Pub. Date: Aug. 27, 2026

(54) IMPLEMENTING ZERO NOISE EXTRAPOLATION WITHOUT FOLDING

(71) Applicant: International Business Machines Corporation, Armonk, NY (US)

(72) Inventors: Ritajit Majumdar, Kolkata (IN); Pedro Rivero Ramirez, Long Island City, NY (US); David Kremer Garcia, White Plains, NY (US); Juan Cruz Benito, Salamanca (ES); Francisco Jose Martin Fernandez, Ridgefield, CT (US); Ivan Duran Martinez, Elmsford, NY (US); Alexandra Rivero García, La Orotava (ES); Ismael Faro Sertage, Chappaqua, NY (US)

(21) Appl. No.: 19/192,039

(22) Filed: Apr. 28, 2025

(30) Foreign Application Priority Data
Feb. 26, 2025 (EP) 25382173.0

(51) Int. Cl. G06N 10/70; G06N 10/20

(52) U.S. Cl. CPC G06N 10/70; G06N 10/20

(57) ABSTRACT

One or more systems, devices, computer program products and/or computer-implemented methods of use provided herein relate to implementing zero noise extrapolation without folding. For example, according to an embodiment, a system is provided. The system can comprise a memory that can store computer-executable components. The system can further comprise a processor that can execute the computer-executable components stored in the memory, where the computer-executable components can comprise an estimation component that can estimate a level of noise of a circuit. The computer-executable components can further comprise a scheduling component that can generate a noise schedule for quantum error mitigation, based on the estimated level of noise. The computer-executable components can further comprise a generation component that can produce transpiled circuits for different noise targets in the generated noise schedule.

### BACKGROUND

The subject disclosure relates to zero noise extrapolation (ZNE) and, more specifically, to performing zero noise extrapolation without folding.

Quantum computing has the capacity to outperform classic computing in various areas. However, one of the fundamental challenges of quantum computing is the presence of noise in quantum hardware. Quantum noise, stemming from decoherence, gate imperfections, and environmental interactions, introduces errors that can degrade the reliability of quantum computations. As a result, error mitigation techniques are essential for extracting useful computational results from near-term quantum devices. One prominent approach to error mitigation is Zero Noise Extrapolation (ZNE), a method that estimates and mitigates the impact of noise in quantum computations without requiring full quantum error correction. ZNE has been successfully used to improve the accuracy of variational quantum algorithms, quantum simulations, and other computational tasks on noisy quantum processors.

However, despite its effectiveness, ZNE suffers from practical limitations. The choice of noise factors and extrapolation methods is often heuristic, requiring expert knowledge or trial-and-error tuning. The selection of noise amplification strategies, the number of noise-scaled circuits, and the choice of extrapolation technique can significantly impact the accuracy of mitigated results. Thus, it can be difficult for users, especially non-experts, to determine optimal settings for specific problems and quantum hardware. Furthermore, implementing ZNE requires generating and executing multiple variants of a quantum circuit with different noise levels, which can be cumbersome and computationally expensive. Thus, while ZNE can be valuable for improving the accuracy of quantum computations, its practical adoption is hindered by difficulties pertaining to the selection of appropriate noise factors and extrapolators.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable performing zero noise extrapolation without folding are discussed.

According to an embodiment, a system is provided. The system can comprise a memory that can store computer-executable components. The system can further comprise a processor that can execute the computer-executable components stored in the memory, where the computer-executable components can comprise an estimation component that can estimate a level of noise of a circuit. The computer-executable components can further comprise a scheduling component that can generate a noise schedule for quantum error mitigation, based on the estimated level of noise. The computer-executable components can further comprise a generation component that can produce transpiled circuits for different noise targets in the generated noise schedule.

According to various embodiments, the above-described system can be implemented as computer-implemented methods or as computer program products.

According to another embodiment, a computer-implemented method is provided. In various embodiments, the computer-implemented method can comprise estimating, by a system operatively coupled to a processor, a level of noise of a circuit. The computer-implemented method can further comprise generating, by a system operatively coupled to a processor, a noise schedule for quantum error mitigation, based on the estimated level of noise. The computer-implemented method can further comprise producing, by a system operatively coupled to a processor, transpiled circuits for different noise targets in the generated noise schedule.

According to yet another embodiment, a computer program product for facilitating zero noise extrapolation without folding is provided. In various embodiments, the computer program product can comprise a non-transitory computer-readable memory having program instructions embodied therewith. In various aspects, the program instructions can be executable by a processor to cause the processor to estimate a level of noise of a circuit. In various cases, the program instructions can be further executable to cause the processor to generate a noise schedule for quantum error mitigation, based on the estimated level of noise. In various embodiments, the program instructions can be further executable to cause the processor to produce transpiled circuits for different noise targets in the generated noise schedule.

### BRIEF DESCRIPTION OF THE DRAWINGS

FIG. 1 illustrates a block diagram of an example, non-limiting system that can facilitate zero noise extrapolation without folding, in accordance with one or more embodiments described herein.

FIG. 2 illustrates another block diagram of an example, non-limiting system that can facilitate zero noise extrapolation without folding, in accordance with one or more embodiments described herein.

FIG. 3 illustrates a flow diagram of an example, non-limiting method that can facilitate zero noise extrapolation without folding, in accordance with one or more embodiments described herein.

FIG. 4 illustrates a flow diagram of an example, non-limiting method that can facilitate zero noise extrapolation without folding, in accordance with one or more embodiments described herein.

FIGS. 5A, 5B and 5C illustrate diagrams of example, non-limiting quantum circuits that can be generated and utilized as part of the non-limiting methods of FIGS. 3 and 4, in accordance with one or more embodiments described herein.

FIG. 6 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to an embodiment, a system is provided. The system can comprise a memory that can store computer-executable components. The system can further comprise a processor that can execute the computer-executable components stored in the memory, where the computer-executable components can comprise an estimation component that can estimate a level of noise of a circuit. The computer-executable components can further comprise a scheduling component that can generate a noise schedule for quantum error mitigation, based on the estimated level of noise. The computer-executable components can further comprise a generation component that can produce transpiled circuits for different noise targets in the generated noise schedule.

Such embodiments of the system can provide a number of advantages, including enhancing accessibility and efficiency of error mitigation, thereby making ZNE more practical for real-world quantum computing applications.

In one or more embodiments of the aforementioned system, the scheduling component can generate a set of noise schedules λ₁, λ₂, . . . , λₖ that conform to a particular extrapolation function. The generated set of noise schedules can conform to a linear extrapolator.

In one or more embodiments of the aforementioned system, the estimation component can select an extrapolator. Noise levels of the produced transpiled circuits can conform to the extrapolator.

In one or more embodiments of the aforementioned system, the system can further comprise an execution component that can execute the transpiled circuits on a quantum hardware. The execution component can measure expectation values of the circuits.

In one or more embodiments of the aforementioned system, the system can further comprise an artificial intelligence component that can train an artificial intelligence model to estimate noise of a circuit. The artificial intelligence component can train an artificial intelligence model to to generate circuits that conform to a particular noise level. The artificial intelligence model can be trained (e.g., by the artificial intelligence component) on execution data of quantum circuits. The execution data can further comprise input circuit structures and corresponding output metrics. The corresponding output metrics can further comprise at least one of expectation values, error rates, or noise characteristics.

According to various embodiments, the above-described systems can be implemented as computer-implemented methods or as computer program products.

According to another embodiment, a computer-implemented method is provided. The computer-implemented method can comprise estimating, by a system operatively coupled to a processor, a level of noise of a circuit. The computer-implemented method can further comprise generating, by the system, based on the estimated level of noise, a noise schedule for quantum error mitigation. The computer-implemented method can further comprise producing, by the system, transpiled circuits for different noise targets in the generated noise schedule.

In one or more embodiments of the aforementioned computer-implemented method, the method can further comprise generating a set of noise schedules λ₁, λ₂, . . . , λₖ that conform to a particular extrapolation function. The generated set of noise schedules can conform to a linear extrapolator.

In one or more embodiments of the aforementioned method, the method can further comprise selecting an extrapolator. Noise levels of the produced transpiled circuits can conform to the extrapolator.

In one or more embodiments of the aforementioned method, the method can further comprise executing the transpiled circuits on a quantum hardware. The method can further comprise measuring expectation values of the circuits.

In one or more embodiments of the aforementioned method, the method can further comprise training an artificial intelligence model to estimate noise of a circuit. The method can further comprise training an artificial intelligence model to generate circuits that conform to a particular noise level. The artificial intelligence model can be trained on execution data of quantum circuits. The execution data can further comprise input circuit structures and corresponding output metrics. The corresponding output metrics can further comprise at least one of expectation values, error rates, or noise characteristics.

Such embodiments of the computer-implemented method can provide a number of advantages, including enhancing accessibility and efficiency of error mitigation, thereby making ZNE more practical for real-world quantum computing applications.

According to another embodiment, a computer program product can comprise a computer readable storage medium having program instructions embodied therewith. The program instructions can be executable by a processor to cause the processor to estimate, by the processor, a level of noise of a circuit. The program instructions can be further executable by the processor to cause the processor to generate, by the processor, based on the estimated level of noise, a noise schedule for quantum error mitigation. The program instructions can be further executable by a processor to cause the processor to produce, by the processor, transpiled circuits for different noise targets in the generated noise schedule.

In one or more embodiments of the aforementioned computer program product, the program instructions can be further executable by a processor to cause the processor to generate, by the processor, a set of noise schedules λ₁, λ₂, . . . , λₖ that conform to a particular extrapolation function. The generated set of noise schedules can conform to a linear extrapolator.

In one or more embodiments of the aforementioned computer program product, the program instructions can be further executable by a processor to cause the processor to select, by the processor, an extrapolator. Noise levels of the produced transpiled circuits can conform to the extrapolator.

In one or more embodiments of the aforementioned computer program product, the program instructions can be further executable by a processor to cause the processor to execute, by the processor the transpiled circuits on a quantum hardware. The program instructions can be further executable by a processor to cause the processor to measure, by the processor, expectation values of the circuits.

In one or more embodiments of the aforementioned computer program product, the program instructions can be further executable by a processor to cause the processor to train, by the processor, an artificial intelligence model to estimate noise of a circuit. The program instructions can be further executable by a processor to cause the processor to train, by the processor, an artificial intelligence model to generate circuits that conform to a particular noise level. The artificial intelligence model can be trained (e.g., by the processor) on execution data of quantum circuits. The execution data can further comprise input circuit structures and corresponding output metrics. The corresponding output metrics can further comprise at least one of expectation values, error rates, or noise characteristics.

Such embodiments of the computer program product can provide a number of advantages, including enhancing accessibility and efficiency of error mitigation, thereby making ZNE more practical for real-world quantum computing applications.

### Definitions

Pauli noise channel A Pauli noise channel or Pauli error channel is a class of theoretical quantum error channels in which errors are described by a set of tensor products of Pauli operators and Pauli error rates.

Quantum noise refers to fluctuations or disturbances in a quantum system that can adversely affect the qubits in the quantum system, thereby compromising the accuracy of quantum computations based on the quantum system. For example, quantum noise can introduce errors in calculations and reduce the reliability of quantum algorithms. To address quantum noise, existing quantum computing techniques typically aim to reduce the negative effects of quantum noise via techniques such as error mitigation, error correction, etc. For example, an existing technique in the art involves quantum reservoir computing for time series modeling. This approach attempts to access the quantum noise inherent in quantum systems, or in case of noiseless systems, to create the noise via a noise model, and employ the quantum noise or noise models to create random temporal dynamics and temporal effects (such as damping over time) that are specifically beneficial for time series modeling. For example, the temporal dynamics and temporal effects can be employed as basis functions to fit a time series model as a linear combination of the basis functions. Another existing technique involves machine learning to make quantum circuits robust to quantum noise or to mitigate quantum noise. Yet another existing (one-off) technique involves finding a specialized hypothetical (non-practical) problem where the benefit of quantum computing over classical computing is robust to quantum hardware noise. Thus, existing quantum computing techniques typically aim to mitigate quantum noise or reduce the effects of quantum noise on quantum computations.

A prominent approach to error mitigation is Zero Noise Extrapolation, a method that estimates and mitigates the impact of noise in quantum computations without requiring full quantum error correction. ZNE involves executing a quantum circuit at different noise levels, observing how the results change as noise increases, and extrapolating result to a zero-noise limit. ZNE can improve the accuracy of variational quantum algorithms, quantum simulations, and other computational tasks on noisy quantum processors.

ZNE can be implemented in different way. For example, Probabilistic Error Amplification (PEA) involves artificially amplifying noise by probabilistically modifying circuit execution, thereby creating a set of noisy results that can be used for extrapolation. ZNE can also be achieved by stretching a duration of quantum gates or by applying additional noise-inducing transformations to a circuit. Once a set of results is obtained at varying noise levels, an extrapolator (such as a linear, polynomial, or Richardson extrapolation) can be applied to estimate an ideal zero-noise result.

However, ZNE suffers from practical limitations. For example, choice of noise factors and extrapolation methods are often heuristic, requiring expert knowledge or trial-and-error tuning. The selection of noise amplification strategies, the number of noise-scaled circuits, and the choice of extrapolation technique can significantly impact the accuracy of mitigated results, making it difficult for users to determine optimal settings. Furthermore, implementing ZNE can require generating and executing multiple variants of a quantum circuit with different noise levels, which can be cumbersome and computationally expensive. Execution must be tailored to characteristics of a quantum backend, as noise behavior can vary across hardware platforms. Consequently, there is a need for systems and methods that can efficiently automate and optimize the generation of noise-scaled quantum circuits while providing reliable noise estimates for ZNE.

The inventors of the subject application realized that the effectiveness of Zero Noise Extrapolation can depend heavily on the choice of noise amplification factors and extrapolation methods, which are often selected heuristically or based on user experience. This can make it challenging for users to systematically determine a best approach for specific problems or quantum hardware. To address this issue, the inventors recognized a need for systems and methods that can automatically generate a sequence of Instruction Set Architecture (ISA) circuits with noise estimates, thereby enabling a structured and efficient approach to error mitigation through ZNE, given an input quantum circuit and a backend.

ISA circuits refer to quantum circuits that are expressed in terms of the native gate set and operational constraints of a given quantum hardware backend. Unlike high-level abstract quantum circuits, which may not directly account for the specific noise characteristics of a hardware platform, ISA circuits can be tailored to a device's physical gate set, execution model, and noise profile. By working at the ISA level, noise-aware modifications can be applied more effectively, thereby ensuring that generated circuit sequences accurately reflect and exploit backend noise characteristics for improved ZNE performance.

In relation to efficiently automating and optimizing generation of noise-scaled quantum circuits while providing reliable noise estimates for ZNE, embodiments of the present disclosure produce a solution to one or more of these problems. These embodiments can solve such problems by estimating a level of noise of a circuit. These embodiments can also include generating a noise schedule for quantum error mitigation, based on the estimated level of noise. The embodiments disclosed herein can further include producing transpiled circuits for different noise targets in the generated noise schedule.

According to an embodiment, a system is provided. The system can comprise a memory that can store computer-executable components. The system can further comprise a processor that can execute the computer-executable components stored in the memory, where the computer-executable components can comprise an estimation component that can estimate a level of noise of a circuit. The computer-executable components can further comprise a scheduling component that can generate a noise schedule for quantum error mitigation, based on the estimated level of noise. The computer-executable components can further comprise a generation component that can produce transpiled circuits for different noise targets in the generated noise schedule.

Such embodiments of the system can provide a number of advantages, including enhancing accessibility and efficiency of error mitigation, thereby making ZNE more practical for real-world quantum computing applications.

In one or more embodiments of the aforementioned system, the scheduling component can generate a set of noise schedules λ₁, λ₂, . . . , λₖ that conform to a particular extrapolation function. The generated set of noise schedules can conform to a linear extrapolator.

In one or more embodiments of the aforementioned system, the estimation component can select an extrapolator. Noise levels of the produced transpiled circuits can conform to the extrapolator.

In one or more embodiments of the aforementioned system, the system can further comprise an execution component that can execute the transpiled circuits on a quantum hardware. The execution component can measure expectation values of the circuits.

In one or more embodiments of the aforementioned system, the system can further comprise an artificial intelligence component that can train an artificial intelligence model to estimate noise of a circuit. The artificial intelligence component can train an artificial intelligence model to generate circuits that conform to a particular noise level. The artificial intelligence model can be trained (e.g., by the artificial intelligence component) on execution data of quantum circuits. The execution data can further comprise input circuit structures and corresponding output metrics. The corresponding output metrics can further comprise at least one of expectation values, error rates, or noise characteristics.

According to various embodiments, the above-described systems can be implemented as computer-implemented methods or as computer program products.

According to another embodiment, a computer-implemented method is provided. The computer-implemented method can comprise estimating, by a system operatively coupled to a processor, a level of noise of a circuit. The computer-implemented method can further comprise generating, by the system, based on the estimated level of noise, a noise schedule for quantum error mitigation. The computer-implemented method can further comprise producing, by the system, transpiled circuits for different noise targets in the generated noise schedule.

In one or more embodiments of the aforementioned computer-implemented method, the method can further comprise generating a set of noise schedules λ₁, λ₂, . . . , λₖ that conform to a particular extrapolation function. The generated set of noise schedules can conform to a linear extrapolator.

In one or more embodiments of the aforementioned method, the method can further comprise selecting an extrapolator. Noise levels of the produced transpiled circuits can conform to the extrapolator.

In one or more embodiments of the aforementioned method, the method can further comprise executing the transpiled circuits on a quantum hardware. The method can further comprise measuring expectation values of the circuits.

In one or more embodiments of the aforementioned method, the method can further comprise training an artificial intelligence model to estimate noise of a circuit. The method can further comprise training an artificial intelligence model to generate circuits that conform to a particular noise level. The artificial intelligence model can be trained on execution data of quantum circuits. The execution data can further comprise input circuit structures and corresponding output metrics. The corresponding output metrics can further comprise at least one of expectation values, error rates, or noise characteristics.

Such embodiments of the computer-implemented method can provide a number of advantages, including enhancing accessibility and efficiency of error mitigation, thereby making ZNE more practical for real-world quantum computing applications.

According to another embodiment, a computer program product can comprise a computer readable storage medium having program instructions embodied therewith. The program instructions can be executable by a processor to cause the processor to estimate, by the processor, a level of noise of a circuit. The program instructions can be further executable by the processor to cause the processor to generate, by the processor, based on the estimated level of noise, a noise schedule for quantum error mitigation. The program instructions can be further executable by a processor to cause the processor to produce, by the processor, transpiled circuits for different noise targets in the generated noise schedule.

In one or more embodiments of the aforementioned computer program product, the program instructions can be further executable by a processor to cause the processor to generate, by the processor, a set of noise schedules λ₁, λ₂, . . . , λₖ that conform to a particular extrapolation function. The generated set of noise schedules can conform to a linear extrapolator.

In one or more embodiments of the aforementioned computer program product, the program instructions can be further executable by a processor to cause the processor to select, by the processor, an extrapolator. Noise levels of the produced transpiled circuits can conform to the extrapolator.

In one or more embodiments of the aforementioned computer program product, the program instructions can be further executable by a processor to cause the processor to execute, by the processor the transpiled circuits on a quantum hardware. The program instructions can be further executable by a processor to cause the processor to measure, by the processor, expectation values of the circuits.

In one or more embodiments of the aforementioned computer program product, the program instructions can be further executable by a processor to cause the processor to train, by the processor, an artificial intelligence model to estimate noise of a circuit. The program instructions can be further executable by a processor to cause the processor to train, by the processor, an artificial intelligence model to generate circuits that conform to a particular noise level. The artificial intelligence model can be trained (e.g., by the processor) on execution data of quantum circuits. The execution data can further comprise input circuit structures and corresponding output metrics. The corresponding output metrics can further comprise at least one of expectation values, error rates, or noise characteristics.

Such embodiments of the computer program product can provide a number of advantages, including enhancing accessibility and efficiency of error mitigation, thereby making ZNE more practical for real-world quantum computing applications.

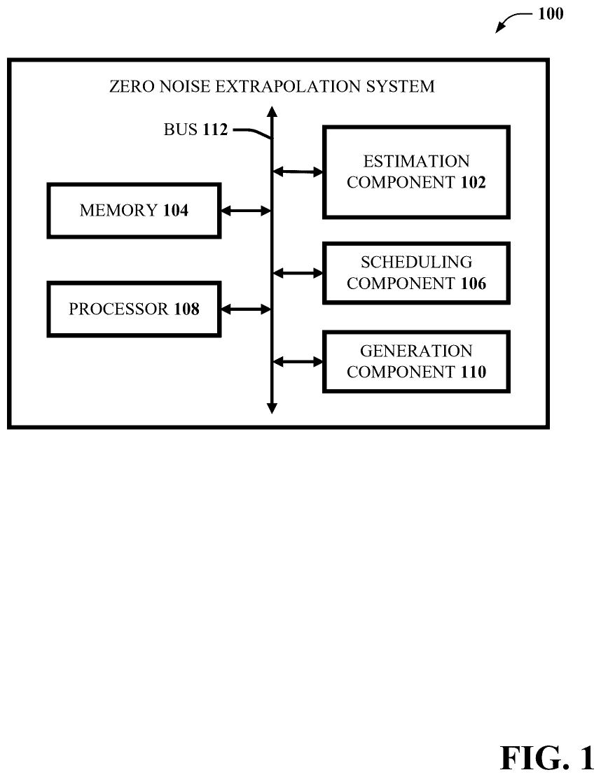

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 700 illustrated at FIG. 7. For example, non-limiting system 100 can be associated with, such as accessible via, a computing environment 700 described below with reference to FIG. 7, such that aspects of processing can be distributed between non-limiting system 100 and the computing environment 700. In one or more described embodiments, computer and/or computing-based elements can be used in connection with implementing one or more of the systems, devices, components and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example system 100 that can facilitate zero noise extrapolation without folding, in accordance with one or more embodiments described herein. The system 100 uses an estimation component 102, a scheduling component 106, and a generation component 110. The estimation component 102 can estimate a level of noise of a circuit. The scheduling component 106 can generate a noise schedule for quantum error mitigation, based on the estimated level of noise. The generation component 110 can produce transpiled circuits for different noise targets in the generated noise schedule.

Aspects of systems (e.g., systems 100, 200, and the like), apparatuses, or processes in various embodiments of the present disclosure can constitute one or more machine-executable components embodied within one or more machines. For example, the components may be embodied in one or more computer readable mediums (or media) associated with one or more machines. Such components, when executed by the one or more machines (e.g., computers, computing devices, virtual machines, etc.) can cause the machines to perform the operations described. System 100 can comprise an estimation component 102, a memory 104, a scheduling component 106, a processor 108, a generation component 110, and a system bus 112.

The system 100 and/or the components of the system 100 may use hardware and/or software to solve problems that are highly technical in nature. The system 100 solves problems that are not abstract and that cannot be performed as a set of mental acts by a human. Further, some of the processes can be performed by specialized computers for carrying out defined tasks related to zero noise extrapolation without folding. The system 100 and/or components of the system 100 can be employed to solve new problems that arise through advancements in technologies. The system 100 can provide technical improvements to zero noise extrapolation by enhancing accessibility and efficiency of error mitigation, thereby making ZNE more practical for real-world quantum computing applications.

The system 100 can include a processor 108. In some embodiments, the processor 108 can execute a component or subcomponent associated with the system 100. Components or subcomponents associated with the system 100 can include one or more machine readable, writable, and/or executable instructions. In some embodiments, the system 100 can include a memory 104, and the memory 104 can store one or more components and/or subcomponents associated with the system 100. In some embodiments, the processor 108 can execute a component stored in the memory 104.

In some embodiments, the system 100 can include a computer-readable memory 104 that may be operably connected to the processor 108. The memory 104 can store computer-executable instructions that, upon execution by the processor 108, can cause the processor 108 and/or one or more other components of the system 100 (e.g., estimation component 102, the scheduling component 106, and/or the generation component 110) to perform one or more actions. In some embodiments, the memory 104 can store computer-executable components (e.g., estimation component 102, the scheduling component 106, and/or the generation component 110).

The system 100 and/or a component thereof as described herein can be communicatively, electrically, operatively, optically, and/or otherwise coupled to one another via a bus 112. The bus 112 can include one or more of a memory bus, memory controller, peripheral bus, external bus, local bus, and/or another type of bus that may employ one or more bus architectures. In some embodiments, the system 100 can be coupled (e.g., communicatively, electrically, operatively, optically, and/or the like) to one or more external systems (e.g., an electrical output production system, one or more output targets, an output target controller, and/or the like). In some embodiments, the system 100 can be coupled to one or more external sources, and/or devices (e.g., classical computing devices, communication devices, and/or like devices), such as via a network. In some embodiments, one or more of the components of the system 100 can reside in the cloud and/or locally in a local computing environment (e.g., at one or more specified locations).

In addition to the processor 108 and/or the memory 104 described above, the system 100 can include one or more computer and/or machine readable, writable, and/or executable components and/or instructions. When executed by the processor 108, these components and/or instructions can enable performance of one or more operations defined by the component(s) and/or instruction(s).

In one or more embodiments of the aforementioned system, the estimation component 102 can estimate the level of noise in a given quantum circuit. As used herein, a quantum circuit can refer to a computational model in quantum computing that represents a sequence of quantum operations (e.g., quantum gates) applied to qubits. Qubits can refer to fundamental units of quantum information. Quantum circuits can execute quantum algorithms by manipulating qubits through unitary transformations and measurements. However, due to hardware imperfections and environmental decoherence, quantum circuits can be prone to noise, which can degrade computational accuracy. To mitigate these effects, the estimation component 102 can first generate an optimized version of an input quantum circuit that can minimize noise through optimal transpilation. Optimal transpilation can refer to a process of converting a high-level quantum circuit into an equivalent representation, tailored to constraints of a specific quantum hardware backend while minimizing error sources. Error sources can include gate errors, decoherence errors, measurement errors, crosstalk errors, and/or calibration errors. By accounting for these error sources, optimal transpilation can reduce overall noise in a quantum circuit. The estimation component 102 can perform techniques such as gate decomposition, qubit routing, and error-aware compilation. The estimation component 102 can reduce the impact of noise by minimizing depth of a circuit, reducing gate errors, and/or optimizing qubit placement.

Once a circuit is optimized, the estimation component 102 can analyze noise characteristics of the transpiled circuit, including factors such as gate, qubit connectivity constraints, and hardware-specific noise profiles. Additionally, the estimation component 102 can select an appropriate extrapolator for zero noise extrapolation. The choice of extrapolator (e.g., linear, polynomial, or Richardson extrapolation) can influence how noise levels are scaled across transpiled circuit variations. The noise levels of the transpiled circuits can conform to the selected extrapolator to ensure that error mitigation through ZNE is both accurate and effective.

In one or more embodiments of the aforementioned system, the scheduling component 106 can generate a noise schedule for quantum error mitigation based on the estimated noise level of the optimized circuit. The noise schedule can be designed to minimize extrapolation error in ZNE by selecting noise amplification factors that align with hardware characteristics and a chosen extrapolation method. Specifically, the scheduling component 106 can generate a sequence of noise scaling factors, denoted as λ₁, λ₂, . . . , λₖ, that can determine how noise is increased in subsequent circuit executions. The noise schedules can conform to a particular extrapolation function, such as linear, polynomial, or Richardson extrapolation, to ensure that noise-amplified circuits provide an accurate foundation for zero-noise estimation. The generated set of noise schedules can be optimized for a linear extrapolator or other extrapolation functions, depending on requirements of an error mitigation strategy.

In one or more embodiments of the aforementioned system, the generation component 110 can produce transpiled circuits corresponding to different noise targets specified in a generated noise schedule. The generation component 110 can modify an original optimized circuit to introduce controlled variations in noise levels. The generation component 110 can ensure that resulting circuits align with predefined noise scaling factors. The generation component 110 can leverage backend-specific noise models, adjust gate repetitions, stretch gate durations, or apply probabilistic error amplification techniques. Each generated circuit can be tailored to a native gate set of a quantum hardware, ensuring that noise amplification remains consistent with physical properties of a backend. The resulting set of transpiled circuits can be executed on a quantum device, allowing for ZNE-based error mitigation through extrapolation.

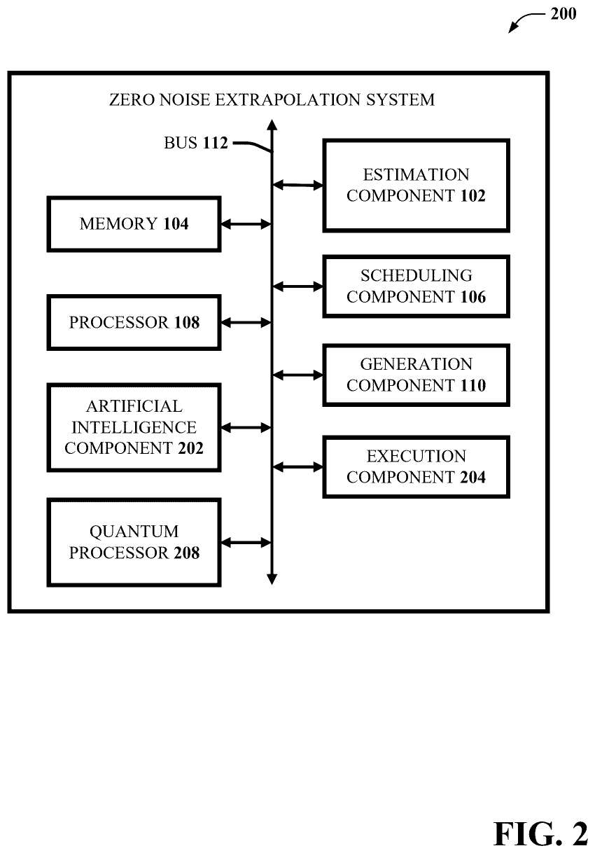

Next, FIG. 2 illustrates an example system 200 that can facilitate zero noise extrapolation without folding, in accordance with one or more embodiments described herein. The system 200 uses an estimation component 102, a scheduling component 106, a generation component 110, an artificial intelligence component 202, and an execution component 204. The estimation component 102 can estimate a level of noise of a circuit. The scheduling component 106 can generate a noise schedule for quantum error mitigation, based on the estimated level of noise. The generation component 110 can produce transpiled circuits for different noise targets in the generated noise schedule. The artificial intelligence (AI) component 202 can train an artificial intelligence model to estimate noise of a circuit and to generate circuits that conform to a particular noise level. The execution component 204 can execute transpiled circuits on a quantum hardware. The system 200 can include a memory 104, processor 108, and a system bus 112. Description of like components has been omitted for the sake of brevity.

The system 200 can include a quantum processor 208. In various embodiments, quantum processor 208 can execute quantum circuits by leveraging quantum mechanical principles. Quantum processor 208 can process information using quantum bits and can utilize properties such as superposition, entanglement, and quantum interference to enhance computational efficiency. Unlike classical processors, which process information sequentially, quantum processor 208 can perform computations in parallel by manipulating quantum states. Quantum processor 208 can initialize qubits into specific quantum states, preparing them for computation. Quantum processor 208 can manipulate qubits by applying quantum gates, which can perform unitary operations to transform a quantum state of a qubit. These transformations can be achieved using physical control mechanisms such as microwave pulses, laser pulses, or electromagnetic fields, depending on underlying quantum hardware implementation. Quantum processor 208 can execute a sequence of quantum gates to evolve qubit states according to a given quantum algorithm. Quantum processor 208 can measure qubits to extract classical information from a quantum system. Measurement can collapse qubits into definitive classical states, allowing computational results to be interpreted and utilized in further processing. Quantum processor 208 can execute multiple repetitions of a quantum circuit to gather statistical data, improving the accuracy and reliability of results in probabilistic quantum algorithms. Quantum processor 208 can be implemented using various quantum hardware architectures. In some embodiments, quantum processor 208 can employ superconducting qubits, where quantum states can be encoded in superconducting circuits and manipulated via microwave pulses. In other embodiments, quantum processor 208 can utilize trapped ions, where individual ions can be confined using electromagnetic fields and controlled with laser pulses. Additional embodiments can include photonic quantum processors, where quantum information can be represented using quantum states of light, and neutral atom-based quantum processors, where neutral atoms can be precisely arranged and controlled using optical tweezers. To enhance computational accuracy, quantum processor 208 can incorporate error mitigation and error correction techniques. Quantum processor 208 can apply zero noise extrapolation to estimate and reduce errors in quantum computations. Additionally, quantum processor 208 can implement fault-tolerant quantum error correction schemes to improve long-term stability and computational reliability.

In various embodiments, the artificial intelligence component 202 can train an artificial intelligence model to estimate the noise of a circuit and to generate circuits that conform to a particular noise level. Artificial intelligence component 202 can leverage heuristic-based or AI-based approaches to analyze a quantum circuit and predict its noise characteristics. The AI model can be trained using execution data from previously run quantum circuits, and can thereby learn patterns between circuit structures and their corresponding noise levels. The execution data can include both input circuit structures and output performance metrics, which can comprise at least one of expectation values, error rates, or noise characteristics derived from real hardware executions. By utilizing an AI-based framework, the artificial intelligence component 202 can estimate noise for new, unseen circuits based on learned correlations from past executions. The system 200 can further incorporate existing heuristics alongside AI-driven methods to refine noise predictions, ensuring flexibility in adapting to different quantum hardware architectures.

In various embodiments, execution component 204 can execute transpiled circuits on a quantum hardware. Execution component 204 can ensure that circuit execution aligns with specific noise characteristics and operational constraints of a backend. Execution component 204 can deploy circuits by interacting with quantum processor 208, utilizing the native gate set and optimized qubit mappings produced during transpilation. Additionally, execution component 204 can manage job scheduling and execution protocols, optimizing circuit execution efficiency while mitigating hardware-induced variations, such as qubit drift and calibration fluctuations, which can impact computational accuracy. The execution component 204 can measure expectation values, which can serve as key indicators of computational accuracy and performance. Expectation values can correspond to observable quantities relevant to the quantum algorithm, such as energy levels in Variational Quantum Eigensolvers (VQE) or probability distributions in quantum machine learning models. In addition to expectation values, execution component 204 can collect other performance metrics, including circuit fidelity, error rates, and noise profiles, to further evaluate execution quality. These measured values can be utilized to refine noise estimation, improve transpilation strategies, and enhance error mitigation techniques such as zero noise extrapolation, ensuring more accurate quantum computations.

In various embodiments, the system 200 can utilize a heuristic or AI-based transpiler technique that can take an input quantum circuit, a backend, and a target noise level to generate a transpiled circuit that, when executed on the backend, aligns with specified noise characteristics. The estimation component 102 can analyze an input quantum circuit and estimate its inherent noise level when executed on a backend. This estimation can leverage either heuristic-based methods or an AI model trained on execution data from prior quantum circuits, enabling the system 200 to predict how noise will manifest in a given backend environment. Additionally, estimation component 102 can determine whether an isomorphic layout of the circuit can provide a configuration that satisfactorily aligns with a target noise level. Scheduling component 106 can generate a noise schedule, defining appropriate transformations required to adjust the circuit's noise profile. This noise schedule can incorporate alternative circuit layouts with varying noise properties to ensure that at least one layout aligns with the target noise level. If isomorphic layouts do not sufficiently match the target noise level, scheduling component 106 can determine whether additional transpilation modifications are required. Generation component 110 can transpile the circuit, either by selecting an isomorphic layout with a noise profile closest to the target or, if such a layout is not available, by applying heuristic-based or AI-driven transpilation techniques to introduce controlled modifications that bring the noise level closer to the target. These modifications can include gate reordering, qubit remapping, gate stretching, or intentional gate insertions, depending on specific error characteristics of the backend. Execution component 204 can execute transpiled circuits on the quantum hardware and measure performance metrics. Results of the measurements can be fed back into an AI model to refine future transpilation strategies, enabling iterative improvement of noise-matching techniques. By leveraging the capabilities of estimation component 102, scheduling component 106, generation component 110, and execution component 204, the system 200 can effectively generate a noise-calibrated transpiled circuit.

In various embodiments, system 200 can determine a set of noise schedules λ₁, λ₂, . . . , λₖ that conform to a specified extrapolation function to facilitate zero noise extrapolation. The scheduling component 106 can generate these noise schedules based on an estimated noise level of an initial transpiled circuit, and can ensure that the noise schedules align with a chosen extrapolation method. For example, scheduling component 106 can determine a sequence such as λ₃=2λ₂ and λ₂=2λ₁, forming a set of noise schedules that lie on a straight line with slope m=2, thereby conforming to a linear extrapolator. In some embodiments, the system 200 can generate isomorphic layouts of the circuit, where different qubit mappings maintain functional equivalence but exhibit varying noise characteristics. The estimation component 102 can analyze these layouts and assign heuristic-based scores to each layout based on estimated noise properties. The system 200 can then fit these scores to a straight line (or another function depending on the selected extrapolation method) to evaluate their suitability for ZNE. The scheduling component 106 can select the top k layouts whose scores deviate minimally from the fitted curve, ensuring that they provide a well-structured noise schedule for accurate extrapolation. In other embodiments, scheduling component 106 can determine noise schedules/by selecting equidistant points along the fitted curve, thereby ensuring uniform distribution of noise levels. If no isomorphic layouts closely match the desired noise schedules, generation component 110 can apply heuristic-based or AI-driven transpilation techniques to modify the circuit while maintaining functional equivalence. This process can involve adjusting qubit mappings, inserting controlled noise-inducing operations, or performing targeted gate transformations to match the predefined noise levels. Once the set of transpiled circuits is generated, the execution component 204 can execute the set of transpiled circuits on quantum hardware and measure their expectation values, error rates, and noise profiles. These execution results can then be processed using the chosen extrapolation function to estimate the zero-noise limit. In an example implementation, isomorphic layouts can be generated and scored using tools for optimizing qubit layouts. The linear extrapolation function can then be applied to these layouts to construct a noise-mitigated result with improved accuracy.

In some embodiments, a linear extrapolator can be sufficient. For example, an n-qubit circuit can have unitary U and a global depolarizing noise channel Λ. On execution, an obtained state can be

$${ρ}_{l} = ( 1 - {p}_{l} ) {ρ}_{i n} + \frac{{p}_{l} I}{{2}^{n}}$$

for a layout l, wherein ρᵢₙ can be a noise-free initial density matrix, ρₗ can be a density matrix whose corresponding quantum circuit has been placed on layout l, and I can be an identity. The expectation value of an observable O can be given as [symbol] O [symbol] =(1−pₗ) [symbol] O [symbol] _{ideal}+pₗ [symbol] O [symbol] _{noisy}, wherein [symbol] O [symbol] can be an expectation value of an observable, and [symbol] O [symbol] can be an expectation value of an observable when a corresponding quantum circuit has been placed on layout l. The circuit can be executed on two layouts l₁ and l₂ such that

$${ρ}_{{l}_{1}} = ( 1 - {p}_{{l}_{1}} ) {ρ}_{i n} + \frac{{p}_{{l}_{1}} I}{{2}^{n}} and {ρ}_{{l}_{2}} = ( 1 - {p}_{{l}_{2}} ) {ρ}_{i n} + \frac{{p}_{{l}_{2}} I}{{2}^{n}} .$$

If pₗ_{₂}=δpₗ_{₁}, wherein δ can be a multiplicative factor (e.g., a real number) which can be a ratio between a noise profile or error probability of the two layouts, then it can be shown that

$${〈 O 〉}_{i d e a l} = \frac{δ}{δ - 1} {〈 O 〉}_{{l}_{1}} - \frac{1}{δ - 1} {〈 O 〉}_{{l}_{2}} .$$

Additionally, the circuit can be twirled to make the channel a Pauli channel. A score sₗ=ƒ(pₗ) can be obtained, which can be used for extrapolation.

According to various embodiments, the above-described systems can be implemented as computer-implemented methods or as computer program products. The systems and/or devices are described herein with respect to interaction between one or more components. Such systems and/or components may include the components and/or sub-components specified therein, one or more of the specified components and/or sub-components, and/or additional components. Sub-components may be implemented as components communicatively coupled to other components rather than included within parent components. One or more components and/or sub-components may be combined into a single component providing aggregate functionality. The components may interact with one or more other components not specifically described herein for the sake of brevity but known by those of skill in the art.

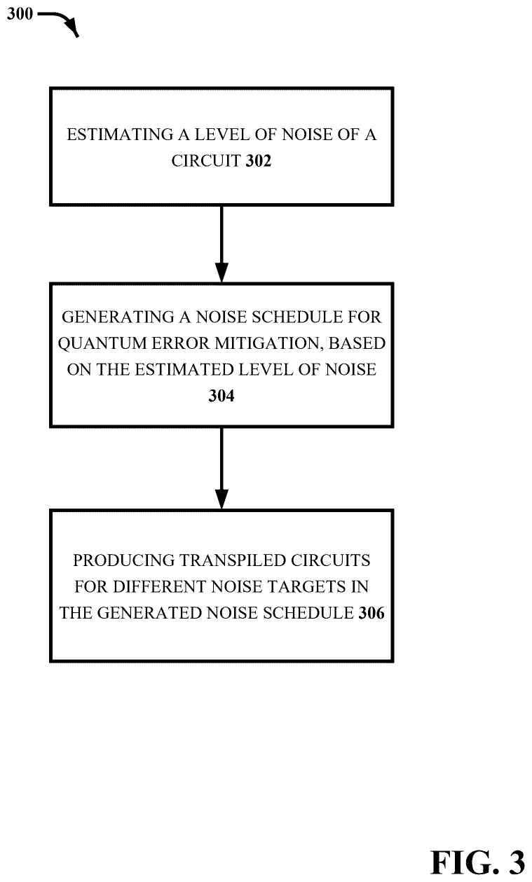

FIG. 3 illustrates an extrapolation flow diagram of a method 300 that can facilitate zero noise extrapolation without folding.

At 302, the method 300 can include estimating a level of noise of a circuit (e.g., via estimation component 102). Estimating the level of noise can involve analyzing a circuit structure, identifying how the structure maps to available qubits and gates on a quantum hardware, and predicting error rates associated with execution. Noise estimation can be performed using heuristic-based techniques or AI models trained on execution data from prior quantum circuits. The estimation process can account for various error sources, including gate errors, qubit decoherence, crosstalk, and readout errors, all of which can contribute to total noise affecting circuit execution. Additionally, 302 can include identifying isomorphic layouts (e.g., alternative mappings of the circuit to different qubit configurations) that can exhibit different noise characteristics. The estimated noise profile can serve as the basis for constructing a noise schedule that can be used for zero noise extrapolation.

At 304, the method 300 can include generating a noise schedule for quantum error mitigation, based on the estimated level of noise (e.g., via scheduling component 106). A noise schedule can define a sequence of noise levels that conform to a chosen extrapolation function, such as a linear, polynomial, or Richardson extrapolation. The noise schedule can be determined by systematically selecting noise amplification factors to optimize extrapolation accuracy. In some cases, step 304 can involve identifying isomorphic circuit layouts and scoring them based on their noise characteristics. These scores can be fitted to a curve representing an extrapolation function, and a top-ranked layouts with minimal deviation from the fitted function can be selected. If isomorphic layouts do not sufficiently match desired noise levels, alternative methods can be used to generate a noise schedule that accounts for controlled circuit modifications (e.g., step 306).

At 306, the method 300 can include producing transpiled circuits for different noise targets in the generated noise schedule (e.g., via generation component 106). Transpilation can involve modifying a circuit to systematically adjust its noise profile while preserving its functional equivalence. Transpilation can include qubit remapping, gate reordering, gate stretching, or inserting controlled noise-inducing operations to align with a predefined noise schedule. If isomorphic layouts were previously selected, corresponding transpiled circuits can be generated accordingly. In cases where isomorphic layouts do not fully achieve target noise levels, heuristic or AI-based transpilation techniques can be applied to ensure compliance with the noise schedule. Once a set of transpiled circuits is generated, the circuits can be executed on a quantum hardware and their results can be used for zero noise extrapolation.

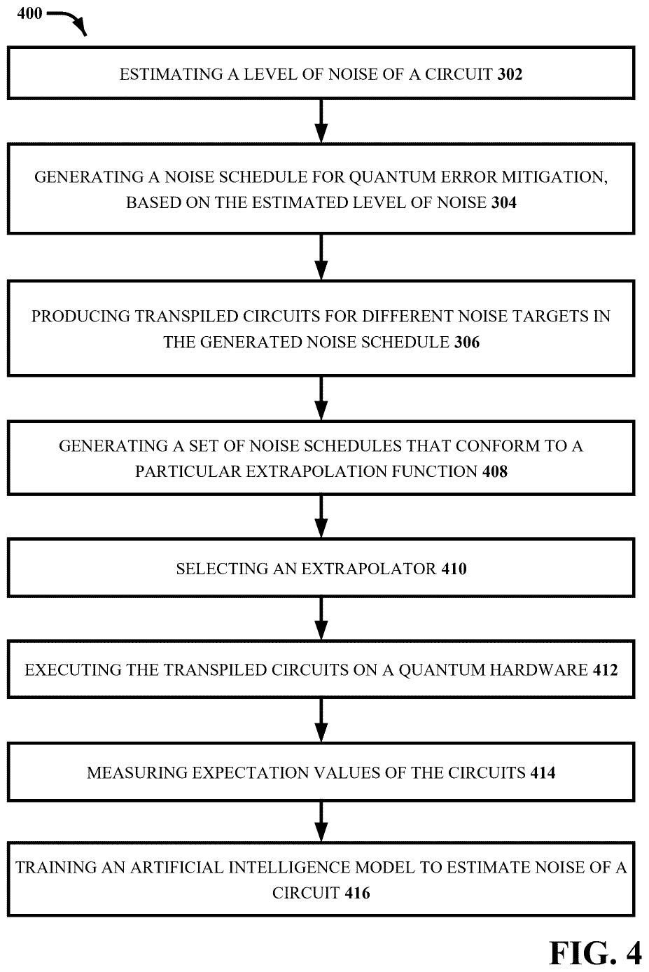

FIG. 4 illustrates an extrapolation flow diagram of a method 400 that can facilitate zero noise extrapolation without folding. Repeated description of like elements has been omitted for the sake of brevity.

At 408, the method 400 can include generating a set of noise schedules that conform to a particular extrapolation function.

A noise schedule can define a sequence of noise levels that can systematically modify noise present in a quantum circuit to facilitate zero noise extrapolation. An extrapolation function can be a mathematical model used to estimate zero-noise result from noisy circuit executions. Examples of extrapolation functions can include linear, polynomial, or Richardson extrapolation, each of which can determine how noise levels in a schedule should be distributed. A noise schedule can be generated by selecting noise amplification factors that align with a chosen extrapolation function. In some embodiments, equidistant noise levels can be selected along a fitted curve to ensure that noise scaling is conditioned for extrapolation. Noise schedule can be determined by analyzing isomorphic circuit layouts, which can represent different mappings of a circuit to a quantum processor with varying noise characteristics. Each layout can be assigned a noise score based on heuristic methods or AI-driven predictions, and top-ranked layouts that conform to an extrapolation function can be selected. If isomorphic layouts do not sufficiently match desired noise levels, alternative techniques can be applied, such as controlled modifications to a circuit's gate structure, qubit routing, or gate duration adjustments to achieve target noise scaling.

At 410, the method 400 can include selecting an extrapolator. In some embodiments, a linear extrapolator can be sufficient. For example, an n-qubit circuit can have unitary U and a global depolarizing noise channel A. On execution, an obtained state can be

$${ρ}_{l} = ( 1 - {p}_{l} ) {ρ}_{i n} + \frac{{p}_{l} I}{{2}^{n}}$$

for a layout l, wherein ρᵢₙ can be a noise-free initial density matrix, ρₗ can be a density matrix whose corresponding quantum circuit has been placed on layout l, and I can be an identity. The expectation value of an observable O can be given as [symbol] O [symbol] =(1−pₗ) [symbol] O [symbol] _{ideal}+pₗ [symbol] O [symbol] _{noisy}, wherein [symbol] O [symbol] can be an expectation value of an observable, and [symbol] O [symbol] can be an expectation value of an observable when a corresponding quantum circuit has been placed on layout l. The circuit can be executed on two layouts l₁ and l₂ such that

$${ρ}_{{l}_{1}} = ( 1 - {p}_{{l}_{1}} ) {ρ}_{i n} + \frac{{p}_{{l}_{1}} I}{{2}^{n}} and$$

$${ρ}_{{l}_{2}} = ( 1 - {p}_{{l}_{2}} ) {ρ}_{i n} + \frac{{p}_{{l}_{2}} I}{{2}^{n}} .$$

If pₗ_{₂}=δpₗ_{₁}, wherein δ can be a multiplicative factor (e.g., a real number) which can be a ratio between a noise profile or error probability of the two layouts, then it can be shown that

$${〈 O 〉}_{i d e a l} = \frac{δ}{δ - 1} {〈 O 〉}_{{l}_{1}} - \frac{1}{δ - 1} {〈 O 〉}_{{l}_{2}} .$$

Additionally, the circuit can be twirled to make the channel a Pauli channel. A score sₗ=ƒ(pₗ) can be obtained, which can be used for extrapolation.

At 412, the method 400 can include executing transpiled circuits on a quantum hardware. Execution can involve running circuits on a quantum processor while ensuring that operations conform to a noise schedule. The execution process can involve submitting quantum jobs to a backend, managing circuit execution order, and handling multiple runs to collect statistical data. Expectation values can be measured from executed circuits, and can represent observable quantities relevant to a quantum algorithm, such as energy levels in variational quantum eigen solvers or probability distributions in quantum machine learning tasks. In addition to expectation values, other performance metrics can be collected, including circuit fidelity, error rates, and noise characteristics, to assess execution accuracy. If multiple noise-scaled circuits are executed, results can be used to perform zero noise extrapolation by fitting measured values to a chosen extrapolation function. Execution can also involve running circuits with different qubit mappings or control parameters to reduce variability in results and improve reliability of extrapolation.

At 414, the method 400 can include measuring expectation values of the circuits. Expectation values can represent an average outcome of a quantum measurement over multiple circuit executions. Measuring expectation values can involve performing repeated executions of a circuit on quantum hardware to gather statistical data. The measured values can correspond to physical observables relevant to a specific computation. Measurement results can be post-processed to reduce an impact of noise. If a circuit is executed at different noise levels as part of a zero noise extrapolation technique, expectation values can be fitted to an extrapolation function to estimate a noise-free result. Additional metrics, such as standard deviations, variances, and statistical confidence intervals, can also be computed to assess the reliability of measured expectation values.

At 416, the method 400 can include training an artificial intelligence model to estimate noise of a circuit. Training can involve collecting execution data from quantum circuits, where each circuit's structure can be paired with corresponding noise characteristics (e.g., gate error rates, decoherence times, crosstalk effects, and readout fidelity). Training data can include both input circuit structures and associated output metrics, such as expectation values, error probabilities, and observed noise levels. The artificial intelligence model can learn patterns between circuit configurations and their noise properties, and can predict noise profiles of new circuits (e.g., circuits that have not been explicitly tested). The AI model can be trained using supervised learning, reinforcement learning, or hybrid approaches that can incorporate physics-based noise models. In some embodiments, the training process can be augmented with heuristic methods, where empirical knowledge about quantum hardware noise can be incorporated to improve estimation accuracy. Once trained, the artificial intelligence model can take a given circuit and estimate noise characteristics without requiring direct execution on quantum hardware, enabling efficient circuit optimization, error mitigation, and noise-aware transpilation strategies.

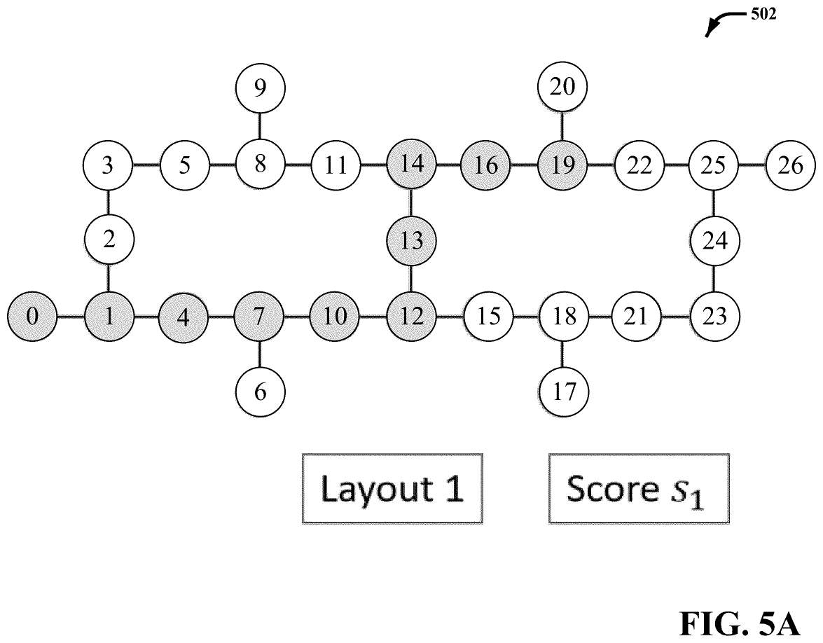

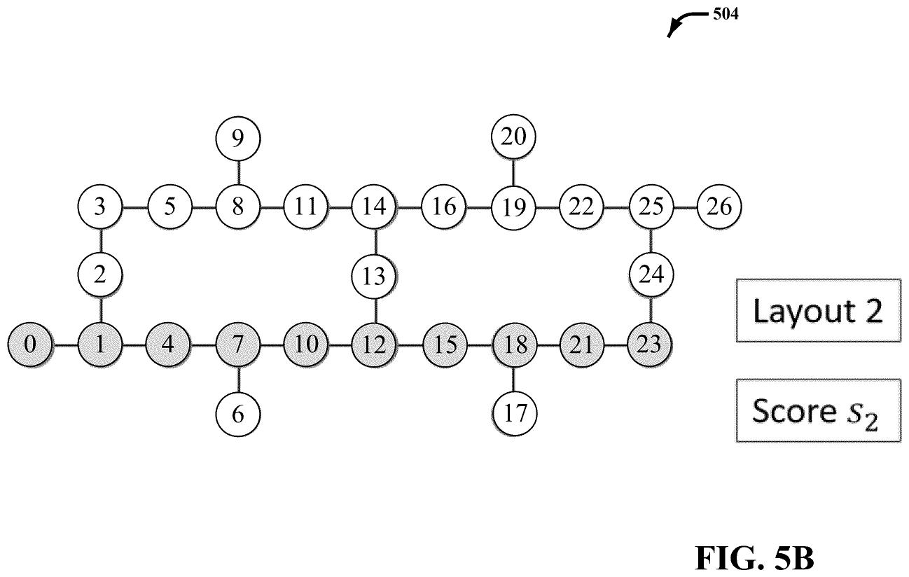

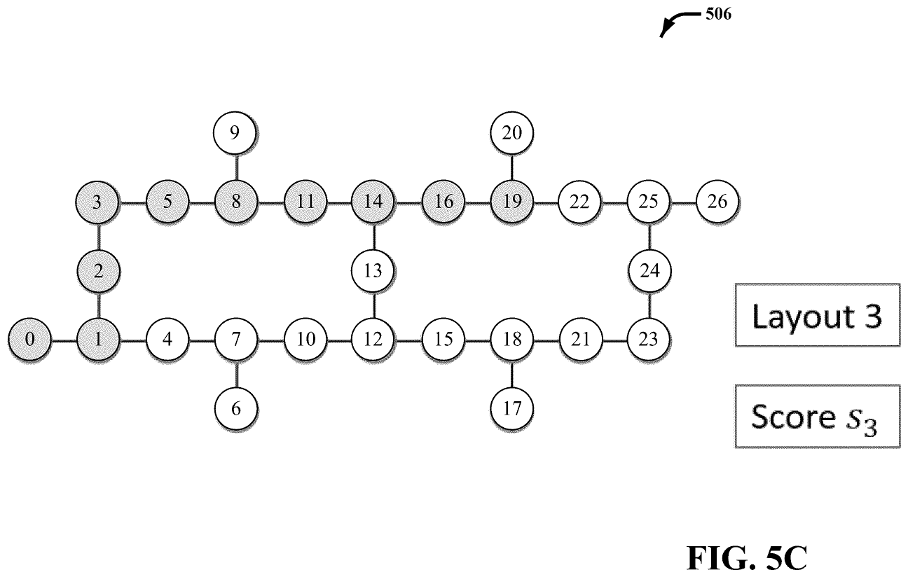

FIGS. 5A, 5B and 5C illustrate diagrams of example, non-limiting quantum circuits that can be generated and utilized as part of the non-limiting methods of FIGS. 3 and 4, in accordance with one or more embodiments described herein. The example, non-limiting quantum circuits of FIGS. 5A, 5B and 5C are 10-qubit circuit on a 27-qubit device. The dark vertices can denote physical qubits used for computation. In the example quantum circuits of FIGS. 5A, 5B and 5C, a decided extrapolator can be linear. The example circuits can be executed on different layouts with non-identical scores. It will be appreciated that outcome will vary depending on a noise profile of a layout. The example circuits can be extrapolated to zero noise.

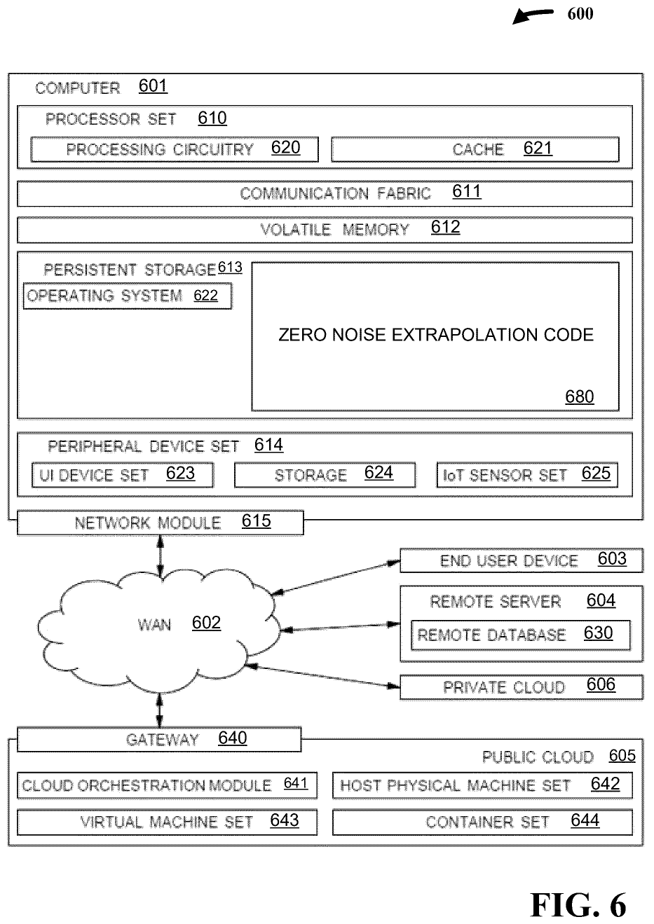

FIG. 6 illustrates a block diagram of an example, non-limiting, operating environment 600 in which one or more embodiments described herein can be facilitated. FIG. 6 and the following discussion are intended to provide a general description of a suitable operating environment 600 in which one or more embodiments described herein at FIGS. 1-6 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as zero noise extrapolation code 680. In addition to block 680, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 680, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer-readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 680 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 680 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer-readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

CLOUD COMPUTING SERVICES AND/OR MICROSERVICES (not separately shown in FIG. 6): private and public clouds 606 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

Various non-limiting aspects of various embodiments described herein are presented in the following clauses.
Clause 1: A system, comprising: a processor that executes computer executable components stored in memory, wherein the computer executable components comprise: an estimation component that estimates a level of noise of a circuit; a scheduling component that generates a noise schedule for quantum error mitigation, based on the estimated level of noise; and a generation component that produces transpiled circuits for different noise targets in the generated noise schedule.
Clause 2: The system of any preceding clause, wherein the scheduling component that generates a set of noise schedules λ₁, λ₂, . . . , λₖ that conform to a particular extrapolation function.
Clause 3: The system of any preceding clause, wherein the generated set of noise schedules conform to a linear extrapolator.
Clause 4: The system of any preceding clause, wherein the estimation component selects an extrapolator.
Clause 5: The system of any preceding clause, wherein noise levels of the produced transpiled circuits conform to the extrapolator.
Clause 6: The system of any preceding clause, further comprising an execution component that executes the transpiled circuits on a quantum hardware.
Clause 7: The system of any preceding clause, wherein the execution component measures expectation values of the circuits.
Clause 8: The system of any preceding clause, further comprising an artificial intelligence component that trains an artificial intelligence model to estimate noise of a circuit and to generate circuits that conform to a particular noise level.
Clause 9: The system of any preceding clause, wherein the artificial intelligence model is trained on execution data of quantum circuits.
Clause 10: The system of any preceding clause, wherein the execution data further comprises input circuit structures and corresponding output metrics.
Clause 11: The system of any preceding clause, wherein the corresponding output metrics further comprise at least one of expectation values, error rates, or noise characteristics.

In various cases, any suitable combination or combinations of clauses 1-11 can be implemented.
Clause 12: A computer-implemented method that utilizes a processor that executes computer executable components stored in memory to perform the following acts: estimating a level of noise of a circuit; generating a noise schedule for quantum error mitigation, based on the estimated level of noise; and producing transpiled circuits for different noise targets in the generated noise schedule.
Clause 13: The method of any preceding clause, further comprising generating a set of noise schedules λ₁, λ₂, . . . , λₖ that conform to a particular extrapolation function.
Clause 14: The method of any preceding clause, wherein the set of noise schedules conform to a linear extrapolator.
Clause 15: The method of any preceding clause, further comprising selecting an extrapolator.
Clause 16: The method of any preceding clause, wherein noise levels of the transpiled circuits conform to the extrapolator.
Clause 17: The method of any preceding clause, further comprising executing the transpiled circuits on a quantum hardware.
Clause 18: The method of any preceding clause, further comprising measuring expectation values of the circuits.
Clause 19: The method of any preceding clause, further comprising training an artificial intelligence model to estimate noise of a circuit.
Clause 20: The method of any preceding clause, further comprising training the artificial intelligence model on execution data of quantum circuits and to generate circuits that conform to a particular noise level.

In various cases, any suitable combination or combinations of clauses 13-18 can be implemented.
Clause 21: A computer program product comprising a computer readable storage medium having program instructions embodied therewith, the program instructions executable by a processor to cause the processor to: estimate a level of noise of a circuit; generate a noise schedule for quantum error mitigation, based on the estimated level of noise; and produce transpiled circuits for different noise targets in the generated noise schedule.

In various cases, any suitable combination or combinations of clauses 1-21 can be implemented.

What is claimed is:

1. A system, comprising:
a processor that executes computer executable components stored in memory, wherein the computer executable components comprise:
an estimation component that estimates a level of noise of a circuit;
a scheduling component that generates a noise schedule for quantum error mitigation, based on the estimated level of noise; and
a generation component that produces transpiled circuits for different noise targets in the generated noise schedule.

2. The system of claim 1, wherein the scheduling component that generates a set of noise schedules λ₁, λ₂, . . . , λₖ that conform to a particular extrapolation function.

3. The system of claim 2, wherein the generated set of noise schedules conform to a linear extrapolator.

4. The system of claim 1, wherein the estimation component selects an extrapolator.

5. The system of claim 4, wherein noise levels of the produced transpiled circuits conform to the extrapolator.

6. The system of claim 1, further comprising an execution component that executes the transpiled circuits on a quantum hardware.

7. The system of claim 6, wherein the execution component measures expectation values of the circuits.

8. The system of claim 1, further comprising an artificial intelligence component that trains an artificial intelligence model to estimate noise of a circuit and to generate circuits that conform to a particular noise level.

9. The system of claim 8, wherein the artificial intelligence model is trained on execution data of quantum circuits.

10. The system of claim 9, wherein the execution data further comprises input circuit structures and corresponding output metrics.

11. The system of claim 10, wherein the corresponding output metrics further comprise at least one of expectation values, error rates, or noise characteristics.

12. A computer-implemented method that utilizes a processor that executes computer executable components stored in memory to perform the following acts:
estimating a level of noise of a circuit;
generating a noise schedule for quantum error mitigation, based on the estimated level of noise; and
producing transpiled circuits for different noise targets in the generated noise schedule.

13. The method of claim 12, further comprising generating a set of noise schedules λ₁, λ₂, . . . , λₖ that conform to a particular extrapolation function.

14. The method of claim 13, wherein the set of noise schedules conform to a linear extrapolator.

15. The method of claim 12, further comprising selecting an extrapolator.

16. The method of claim 15, wherein noise levels of the transpiled circuits conform to the extrapolator.

17. The method of claim 12, further comprising executing the transpiled circuits on a quantum hardware.

18. The method of claim 17, further comprising measuring expectation values of the circuits.

19. The method of claim 12, further comprising training an artificial intelligence model to estimate noise of a circuit.

20. A computer program product comprising a computer readable storage medium having program instructions embodied therewith, the program instructions executable by a processor to cause the processor to:
estimate a level of noise of a circuit;
generate a noise schedule for quantum error mitigation, based on the estimated level of noise; and
produce transpiled circuits for different noise targets in the generated noise schedule.
